(19) United States
(12) Patent Application Publication
(10) Pub. No.: US 2015/0124318 A1
(43) Pub. Date: May 7, 2015

(54) HIGH MAGNETIC FIELD-TYPE MULTI-PASS FARADAY ROTATOR

(71) Applicant: Electro-Optics Technology, Inc., Traverse City, MI (US)

(72) Inventor: David Gerald Scerbak, Traverse City, MI (US)

(21) Appl. No.: 14/524,846

(22) Filed: Oct. 27, 2014

Related U.S. Application Data
(60) Provisional application No. 61/900,080, filed on Nov. 5, 2013.

(51) Int. Cl. G02F 1/09

(52) U.S. Cl. CPC G02F 1/093; G02F 2201/17; G02F 2203/06
USPC 359/484.04; 359/484.03

(57) ABSTRACT

A multi-pass-type Faraday rotator useful in an optical isolator is provisioned with high-efficiency, high-field permanent magnets formed with minimal magnetic material. A high magnetic field is generated by two sets of magnets attached to outer pole plates that are mirror images of each other. Like-type poles of the magnets in each set are disposed against each other above and below the beam path plane of a multi-pass Faraday optic. Each set of magnets is formed of a central block of magnetic material with magnetization oriented substantially parallel to the multi-pass beam path on the Faraday optic, adjoined by adjacent blocks of magnetic material with magnetization oriented substantially perpendicular to the central magnet block and with like poles to the central magnet block where the magnets border the multi-pass Faraday optic.

### CROSS-REFERENCES TO RELATED APPLICATIONS

This application claims benefit under 35 U.S.C. 119(e) to provisional patent application Ser. No. 61/900,080 filed 5 Nov. 2013.

### STATEMENT AS TO RIGHTS TO INVENTIONS MADE UNDER FEDERALLY SPONSORED RESEARCH AND DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention relates generally to Faraday rotators and Faraday rotators used in optical isolators, and, more particularly, to design of permanent magnet based efficient, uniform high fields for use in multi-pass Faraday rotators.

Optical isolators are routinely used to decouple a laser oscillator from downstream laser amplifier noise radiation and/or target reflections. The key elements of an optical isolator are shown schematically in FIG. 1. Optical isolators use non-reciprocal magneto-optic polarization rotation in a Faraday rotator 6 comprised of a Faraday optic 4 in a strong magnetic field 5 co-axial with the laser radiation along axis 1 from laser source 2 to rotate the plane of polarization 45°. Surrounding the Faraday rotator 6 by polarizers 3, 7 aligned with the input and output linear polarization states respectively completes the optical isolator. Because Faraday effect rotation is non-reciprocal (i.e. the sense of rotation does not depend upon the direction of propagation), any backward propagating radiation will have the plane of linear polarization rotated a further 45° resulting in a polarization state which is 90° to the transmission axis of the input polarizer—where it will consequently experience high backward transmission loss as rejected beam 9. This reverse radiation loss is typically on the order of 30 dB for single stage optical isolators. An optional 45° quartz rotator 7 with the same sense of rotation in the forward, transmission direction as the 45° of Faraday rotation in Faraday rotator 6 to flip the input and output polarization states by 90°. The rotation sense of reciprocal quartz rotator 7 is opposite that of nonreciprocal Faraday rotation in Faraday optic 4 in the reverse, isolation, direction such that dispersion of reciprocal and nonreciprocal rotations largely cancel to achieve broadband isolation. (For reference see P. A. Schulz “Wavelength independent Faraday isolator”, Appl. Opt. 28, 4458-4464 (1989)).

The amount of Faraday rotation is given by:

θ(λ,T)=V(λ,T)×H(r,T)×L_{F} (1)

where:
θ(λ,T): The Faraday rotation angle (a function of wavelength, λ, and temperature, T);
V(λ,T): A proportionality constant, termed the Verdet constant, of the Faraday element (a function of wavelength, λ, and temperature, T);
H(r,T): The strength of the magnetic field in the direction of light through the Faraday element (a function of radial position r across the beam and temperature, T); and
L_{F}: The length of the Faraday element.

In order to make an optical isolator as small and inexpensive as possible, the Faraday rotation is desired to be large. Equation 1 states that the Faraday rotation angle can be increased by either an increase in the Verdet constant V (λ,T), the magnetic field strength H(r,T), or the Faraday element length L_{F}. Because the Faraday effect is enhanced near an absorption, it is often desirable to reduce, rather than increase, the Faraday element length L_{F} required to achieve the desired 45° of Faraday rotation in order to minimize undesirable heating due to absorbed power in a Faraday element. Especially when used with high power lasers, absorbed power in a Faraday element is known to cause a temperature gradient across the laser beam profile which results in deleterious thermal effects such as thermal birefringence and thermal lensing. Thermal birefringence can reduce the maximum isolation of an optical isolator well below the typical 30 dB level. Thermal lensing can significantly shift the position of a focus along the axis of beam propagation when the source laser power is varied and thereby change the desired results in a process or experiment which relies on stable laser beam focusing. For at least these reasons, high performance optical isolators for use with high power laser beams seek to minimize the length L_{F} of the Faraday element.

As noted above, equation 1 also states that Faraday rotators using Faraday elements with the largest Verdet constant can achieve the desired 45° of polarization rotation with shorter Faraday elements L_{F}, lower magnetic fields H(r,T), or both. Because they are ferromagnetic, Faraday elements used in high volume telecom isolators with wavelengths from 1.3 to 1.55 μm have extremely large Verdet constants>1,500 degrees per (kGauss−cm) and can therefore be extremely small and inexpensive. However, Faraday elements used in optical isolators at common high power laser wavelengths near 1 μm cannot always use ferromagnetic materials due to high absorption from iron in the crystal structure and therefore usually use much lower Verdet paramagnetic or diamagnetic Faraday elements. Faraday rotators near 1 μm commonly use paramagnetic Faraday elements which typically contain significant amounts of terbium in a glass, crystalline or ceramic optical host. The most commonly used Faraday optic material near 1 μm has been terbium gallium garnet single crystal (“TGG”). Recently, a polycrystalline ceramic form of TGG (“cTGG”) has become available. Terbium glasses are typically used only for very large aperture Faraday rotators that require Faraday elements of larger dimension than are available in single crystal or ceramic form because they have even lower Verdet constants and greatly increased deleterious thermal effects due to their low thermal conductivity. The Verdet constant of paramagnetic terbium based single crystals and ceramics is currently limited to 2 to 3 degrees of polarization rotation per (kGauss−cm)—at least 500× less than ferromagnetic Faraday elements used in telecom optical isolators. For this reason, designers of

Faraday rotators and optical isolators for use near 1 μm have sought to use magnetic designs which provide for the highest magnetic fields that are practically achievable with readily available permanent magnets.

Because the Faraday effect requires magnetic fields to be co-axial with light propagation through a Faraday optic, conventional single pass “straight through” Faraday rotators have gap lengths (the distance between magnetic pole faces) that are similar to the length of the Faraday optic(s). A fundamental tenet of permanent magnet design is that it is easiest to produce high fields across short gaps. In order to achieve high fields across short gaps with a minimal amount of permanent magnet material, prior art efforts have used multi-pass Faraday rotators because the effective gap length is effectively reduced by the number of passes through the multi-pass Faraday optic.

U.S. Pat. Nos. 4,909,612 and 5,715,080 describe multi-pass Faraday rotators wherein two pairs of oppositely poled adjacent block magnets with magnetization normal to the plane of a multi-pass beam path are serially disposed and on opposite sides of a multi-pass Faraday rotator slab with poles of like polarity being disposed in transverse registration on opposite sides of the beam path to produce an intense magnetic field substantially parallel to the beam path of a laser beam passing through the material. U.S. Pat. No. 5,715,080 teaches that adjacent magnets of each pair of magnets on opposite sides of a multi-pass Faraday rotator slab are spaced apart in order to greatly reduce magnetic field non-uniformity present in the magnet configuration shown in U.S. Pat. No. 4,909,612. However, high magnetic field magnets require use of rare and thus expensive materials, so there is a premium on material usage.

What is needed is an efficient multi-pass Faraday rotator magnet configuration that maximizes magnetic field generation with minimal material.

### SUMMARY OF THE INVENTION

According to the invention, a multi-pass-type Faraday rotator useful in an optical isolator is provisioned with high-efficiency, high-field permanent magnets formed with minimal magnetic material. A high magnetic field is generated by two sets of magnets attached to outer pole plates that are mirror images of each other. Like-type poles of the magnets in each set are disposed against each other above and below the beam path plane of a multi-pass Faraday optic.

Each set of magnets is formed of a central block of magnetic material with magnetization oriented substantially parallel to the multi-pass beam path on the Faraday optic, adjoined by adjacent blocks of magnetic material with magnetization oriented substantially perpendicular to the central magnet block and with like poles to the central magnet block where the magnets border the multi-pass Faraday optic. Highly uniform magnetic fields that are approximately two-fold stronger than prior art multi-pass Faraday rotator magnet configurations are realized.

Internal pole pieces are shaped to further increase magnetic fields within the multi-pass Faraday optic. The central block magnet in one or both magnet sets may optionally have projections that surround the non-optical sides of the Faraday optic, approximating a single axial magnet with a central hole to further direct and increase magnetic field within the Faraday optic.

An isotropic Faraday rotation material, with or without thermally conductive transparent windows bonded to it, can be used as the multi-pass Faraday optic. One or both magnet sets may be translated normal to the plane of the multi-pass beam path in order to tune the strength of the magnetic field. High refractive index first deposition layers are used for thin film reflective mirrors deposited directly on the multi-pass Faraday optic to maintain linear polarizations for reflected beams. Slab shaped multi-pass Faraday optics are passively heat sunk to the housing or actively temperature stabilized with a thermoelectric cooler or heater to maintain constant Faraday rotation with changing ambient temperature.

The present invention is an improvement over U.S. Pat. Nos. 4,909,612 and 5,715,080. Unlike the prior art configuration, the present invention uses a third central block magnet between each pair of magnets with a magnetization that is substantially parallel to the multi-pass beam path through a Faraday optic. Within each magnet set, the central block magnet has pole faces that are the same polarity as adjacent block magnets where they border the multi-pass Faraday optic. Outer pole plates on each magnet set are used to reduce external leakage fields and direct them towards the multi-pass Faraday optic. Highly uniform magnetic fields are achieved that are approximately two-fold stronger than that of the apparatus disclosed in U.S. Pat. No. 5,715,080 for a similar total amount of permanent magnet material. This is commercially important when preferred rare-earth permanent magnets are used in view of recent disruptions in the availability of rare earths and corresponding rapid >20× price fluctuations for dysprosium and neodymium, commonly used elements in rare earth magnets. Reduced demand for dysprosium and neodymium may result for use of a magnet configuration as herein described.

An important benefit of the invention is that the stronger uniform magnetic fields produced by the present invention using a comparable amount of permanent magnetic material as that disclosed in U.S. Pat. No. 5,715,080 allows for an approximate two-fold reduction in total beam path length through the multi-pass Faraday optic. A shortened beam path length in the Faraday optic reduces deleterious thermal effects, such as thermal birefringence and thermal lens focal shifts in a Faraday rotator used with high average power lasers, or nonlinear refractive index phase shifts resulting from high beam intensities in short pulse lasers.

One aspect of the present invention is that shaped internal pole pieces may be used to further concentrate uniform fields substantially along the multi-pass beam path within the Faraday optic.

Another aspect of the invention is that one or both central magnet blocks have projections such that the central magnet blocks substantially surround the non-optical surfaces of said Faraday optic to further increase magnetic field strength in the region of the Faraday optic.

Another aspect of the invention is that one or both sets of magnets may be translated normal to the plane of the multi-pass beam path in order to tune the strength of the magnetic fields and Faraday rotation within the Faraday optic.

Another aspect of the invention is that high reflection thin film coatings applied directly to the Faraday optic to define a multi-pass beam path have a first high index deposition layer of higher refractive index than the Faraday optic refractive index in order to maintain a linear polarization of a reflected beam.

Yet another aspect of the present invention is that it is suitable for use with any diamagnetic, paramagnetic, or semiconductor isotropic Faraday rotator material that may be either a glass, transparent polycrystalline ceramic or single crystal.

In accordance with this aspect of the invention, all of these Faraday rotator materials may have transparent heat-conductive layers of thermally significant thickness bonded to their optical faces in order to minimize thermal gradients across the beam within the Faraday optic.

A final aspect of the present invention is that slab shaped multi-pass Faraday optics may be readily heat sunk to the housing or actively temperature stabilized with a thermoelectric cooler or heater as desired to maintain substantially constant Faraday rotation.

The invention will be better understood by reference to the following detailed description in connection with the accompanying drawings.

### BRIEF DESCRIPTION OF THE DRAWINGS

FIG. 1 is a schematic view of the essential elements of an optical isolator according to the prior art.

FIG. 2 a cross section plan view of a multi-pass Faraday rotator of the present invention along the cross section line labeled 2-2 in FIG. 3 suitable for use in a polarization independent optical isolator.

FIG. 3 is the cross section side view along path 3-3 in FIG. 2

FIG. 4 is a cross section plan view of a multi-pass Faraday rotator of the present invention along cross section line 4-4 in FIG. 5 suitable for use in a polarization maintaining optical isolator.

FIG. 5 is a cross section side view along path 5-5 in FIG. 4.

FIG. 6 is a cross section side view along path 6-6 in FIG. 4.

### DETAILED DESCRIPTION OF THE INVENTION

In a first embodiment of the invention, a Faraday rotator using the magnet design of this invention is used with a beam that is reflected in a multi-pass Faraday optic having an optically transparent input face portion, at least one reflective coated opposite face portion and an optically transparent output face portion. In the case of a two-pass Faraday rotator, substantially all of one optical face of the Faraday optic is coated with a high reflection coating, and substantially all of the other opposite optical face is anti-reflection coated to serve as both the input and output transparent faces.

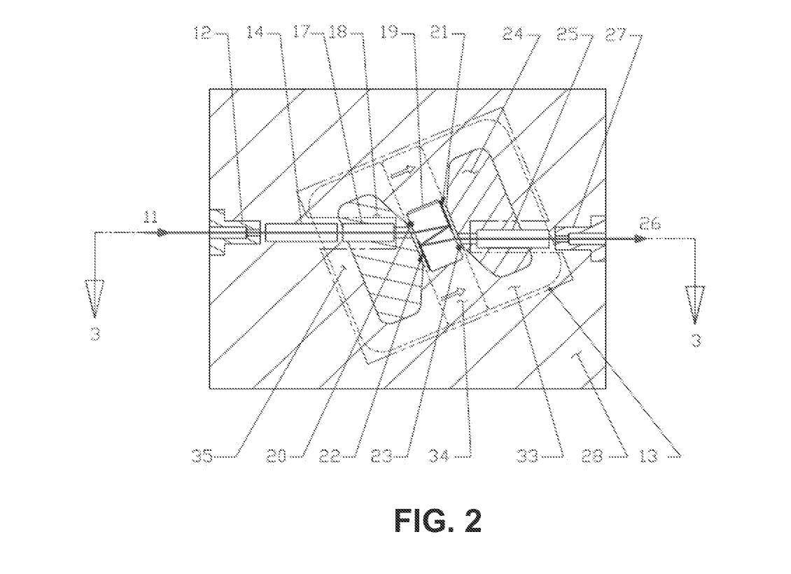

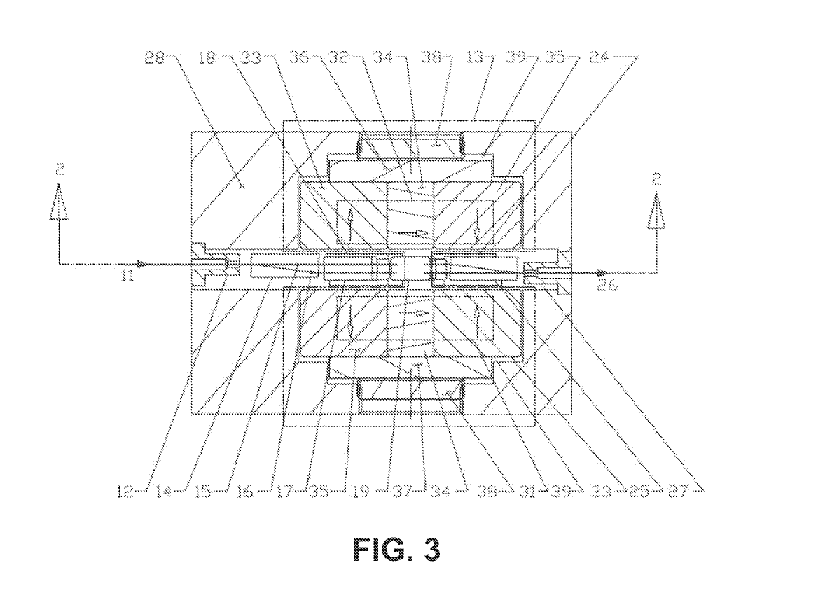

In the case of a 3 or more pass Faraday rotator, each optical face of the Faraday optic is coated with both a transparent portion(s) and a reflective portion as shown in FIG. 2 which is a cross section plan view along the line labeled 2-2 in FIG. 3 of multi-pass Faraday rotator 13 used in a polarization insensitive optical isolator. Randomly polarized radiation such as from a pulsed fiber laser is propagated in an approximately 0.5 mm collimated beam 11 through aperture 12 of Faraday rotator 13. Collimated beam 11 is directed through input Vanadate crystal polarization displacer 14. Input Vanadate polarization displacer 14 resolves the randomly polarized collimated beam 11 into orthogonally polarized o-ray 15 and e-ray 16 shown in FIG. 3 before transmitting both rays through 45° crystal quartz rotator 17 which is mounted in a channel of input inner pole 18. Both beams are transmitted through a generally rectangular aperture in input pole 18 and are then incident on optically transparent input face portion 20 of slab shaped ceramic TGG multi-pass Faraday optic 19. Faraday optic 19 is bonded and heat sunk to housing 28. After transmission through transparent input face portion 20 the beams propagate through Faraday optic 19 until they are reflected by a first high reflection coating 21 onto a second high reflection coating 22 and then propagate out of Faraday optic 19 through transparent output face portion 23.

According to an aspect of the invention used in this embodiment, reflective coated portions 21, 22 are multi-layer high reflector thin film coatings at the wavelength range of interest, wherein the first deposition layer onto the Faraday optic 19 for each multi-layer stack of high/low refractive index layers comprising the thin film reflective coating 21, 22 is a high refractive index layer with higher refractive index than the Faraday optic 19 material. Such first high index layer eliminates the need for an additional waveplate when the Faraday rotator of this invention is used in an optical isolator to compensate for phase shifts that would otherwise occur for the non-normal reflections at the high reflective mirror coatings as described in U.S. Pat. Nos. 4,909,612 and 5,715,080. Transparent input and output face portions 20, 23 are typically anti-reflection coatings on the Faraday optic 19. The two orthogonally polarized beams 15 and 16 are then propagated through a generally rectangular aperture in output inner pole 24 and then recombined (after 45° of Faraday rotation in multi-pass Faraday optic 19 and 45° quartz rotator 17) in output Vanadate crystal displacer 25 mounted in a channel in output inner pole 24 into a single randomly polarized output beam 26 which is transmitted through output aperture 27.

Referring to FIG. 3, the Faraday rotator 13 of this embodiment comprises a lower magnet set 31 and upper magnet set 32. Each magnet set comprises three magnets. Magnets 33 and 35 have magnetization normal to the multi-pass beam path plane and, for example, polarity indicated by the arrows on each magnet. Magnets 34 have magnetization substantially parallel to the multi-pass beam path with magnetization and, for example, polarity indicated by the arrows on each magnet in FIG. 3 The polarity of each magnet within a set, and between sets 31 and 32 in transverse registration to each other, is such that each magnet has like poles to adjacent magnets at their boundary edges nearest to the multi-pass Faraday optic 19, for example as shown in FIG. 3. For reference and clarity, magnets 35, 34 and 33 of the lower magnet set 31 are shown as hidden dashed lines in FIG. 2 because they are obscured by the housing 28 in the cross section plan view of FIG. 2.

In FIG. 3 internal pole pieces 18, 24 are used in accordance with the invention to enhance magnetic field strength and further improve uniformity in this embodiment of the invention. Transmission holes in internal poles 18, 24 further function as input and/or output apertures which define a single beam path of the correct number of passes through the Faraday rotator 13 to achieve the desired rotation. High permeability outer pole pieces 36 and 37 reduce external fields from upper magnet set 32 and lower magnet set 31 and thereby further increase the magnetic field in the region of Faraday optic 19. Tuning screws 38 may be used to adjust gaps 39 to tune the magnetic field strength and Faraday rotation angle in Faraday optic 19 to the desired 45° at the fiber laser center frequency of 1064 nm. The 45° quartz rotator 17 is used with 45° of Faraday rotation in multi-pass Faraday optic 19 to conveniently flip the input and output polarization states in the transmission direction such that the displacement planes of input 14 and output 25 Vanadate displacers lie in the same plane. The rotation sense of reciprocal quartz rotator 17 is also opposite that of nonreciprocal Faraday rotation in multi-pass Faraday optic 19 in the reverse, isolation, direction such that dispersion of reciprocal and nonreciprocal rotations largely cancel to achieve broadband isolation. The high performance, small size, and low cost of the Faraday rotator of this embodiment is particularly useful with small beams such as used with polarization insensitive (“PI”) or polarization maintaining (“PM”) optical isolators for use with high power randomly polarized and linearly polarized fiber lasers respectively.

In a second embodiment of the invention, a multi-pass Faraday rotator using the magnet design of this invention is constructed with at least one external mirror and substantially all of one or both optical faces of the Faraday optic being anti-reflection coated. If internal pole pieces are used to enhance magnetic field strength, multiple transmission holes and/or slots are used in the internal poles as appropriate to permit transmission of the input and output beams as well as reflection(s) from any external mirrors. This Faraday rotator embodiment of the invention is particularly well suited for use in optical isolators used with larger beam diameters and higher peak powers such as sub-nanosecond ultrafast laser sources and/or multi-kW average power lasers when anti-reflection coated transparent heat conductive windows are bonded to the multi-pass Faraday optic.

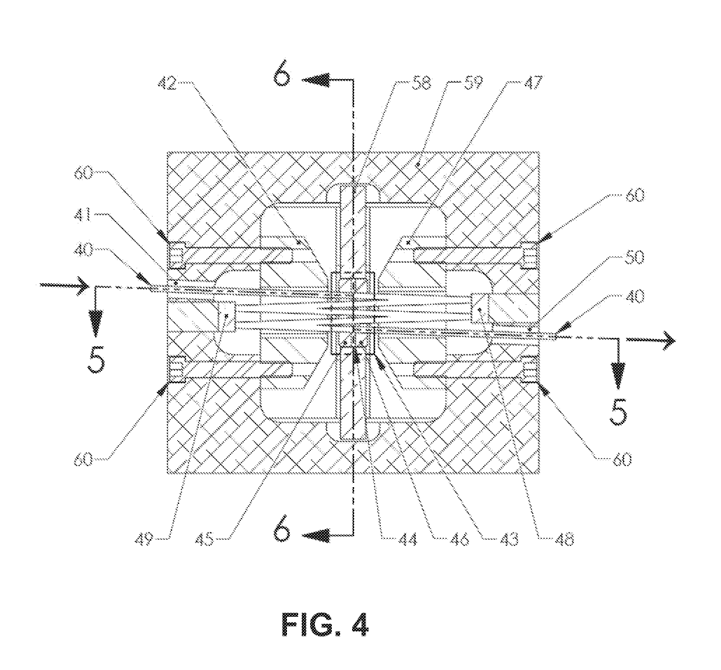

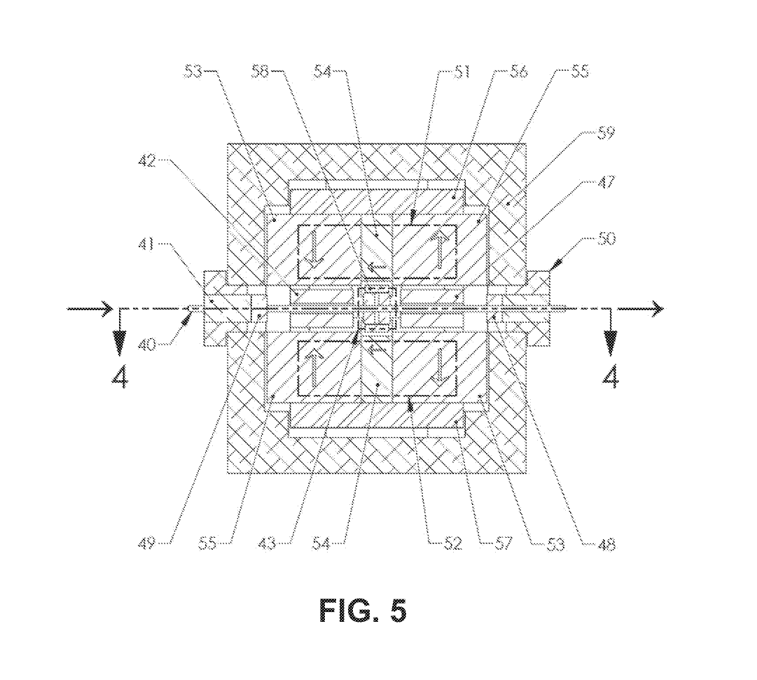

FIG. 4 is a cross section plan view of a Faraday rotator along the line labeled 4-4 in FIG. 5 for use in a polarization maintaining optical isolator for a CO₂ laser at 10.6 μm in accordance with this second embodiment. Polarized 10.6 μm radiation is directed along beam path 40 into input aperture 41 of the multi-pass Faraday rotator. 10.6 μm radiation along beam path 40 is transmitted through a slot in input inner pole 42 into Faraday optic 43. Faraday optic 43 is comprised of an inner layer of InSb 44 that is bonded, such as by diffusion bonding, to transmissive heat conducting germanium windows 45 and 46. Because both InSb and Ge have nearly identical refractive indices at 10.6 μm, transmissive Ge windows 45 and 46 are only anti-reflection coated on the two optical surfaces not bonded to InSb. After the first transmission pass through Faraday optic 43, the beam path 40 passes through a slot in output inner pole 47 and is then reflected between first reflection mirror 48 and second reflection mirror 49 such that beam path 40 makes a total of 5 passes through Faraday optic 43 before the beam path exits the Faraday rotator through output aperture 50 Inner poles 42, 47 are secured to the housing 59 with screws 60. A copper mount 58 provides a heat conduit to the housing 59 for absorbed power from the Faraday optic 43.

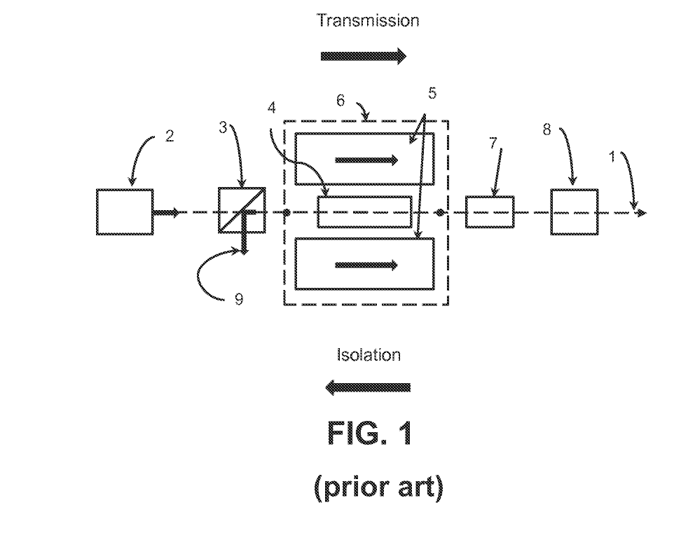

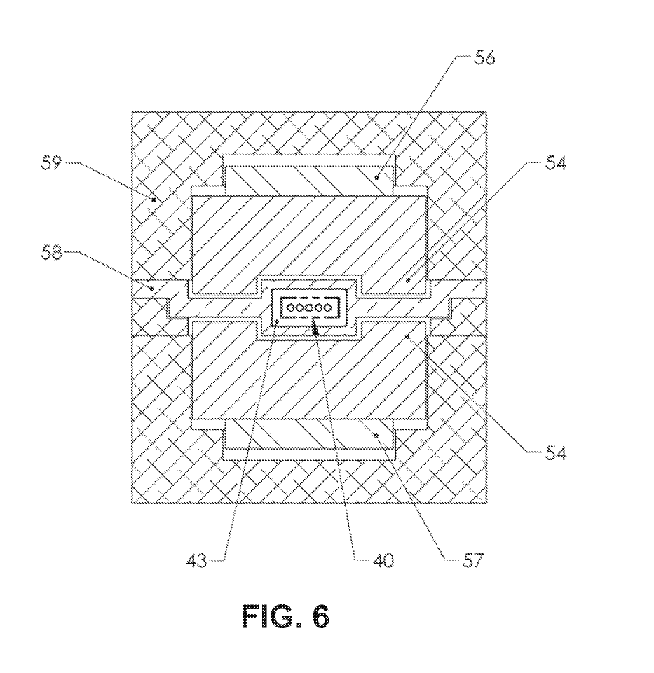

FIG. 5 is a cross section side view along the line labeled 5-5 in FIG. 4. The magnet geometry of this embodiment is similar to the first embodiment with an upper magnet set 51 and lower magnet set 52. Magnets 53 and 55 have magnetization normal to the multi-pass beam path 40 plane and, for example, polarity indicated by the arrows on each magnet. Central magnets 54 have magnetization substantially parallel to the multi-pass beam path with magnetization and polarity as indicated in FIG. 5. Central magnets 54 can be slightly recessed as shown to provide additional space for heat sinking of the Faraday optic 43 or temperature controlling it with heaters or thermo-electric coolers as appropriate. In this embodiment, as shown in FIG. 6 which is a cross section side view along line 6-6 of FIG. 4, central magnets 54 have protrusions such that the central magnets 54 generally surround the non-optical surfaces of the Faraday optic 43 in order to further increase the magnetic fields in the region of the Faraday optic 43. Upper and lower outer poles 56 and 57 have the same function as outer poles in the first embodiment. Spacing the reflection mirrors 48 and 49 as appropriate allows the beam diameter and degree of beam overlap between multi-passes in the Faraday optic 43 shown in FIG. 4 to be adjusted as desired enabling the Faraday rotator of this embodiment to be used with high peak power laser beams to prevent damage to optical elements in the device. In accordance with the prior art discussion and FIG. 1, a polarization maintaining optical isolator suitable for use with CO₂ lasers at 10.6 μm can be realized by surrounding the Faraday rotator of this embodiment with polarizers with transmission axis at 45° to each other (such as thin film Brewster angle ZnSe) at the input and output ends of the Faraday rotator.

The invention has been described with reference to specific embodiments. Other embodiments will be evident to those of ordinary skill in the art. It is therefore not intended that the invention be limited, except as indicated by the appended claims.

What is claimed is:

1. A multi-pass Faraday rotator comprising:
an optical input port;
an optical output port;
a Faraday optic comprising a block of optically transparent material capable of Faraday effect rotation, said Faraday optic longitudinally disposed on a beam path between said optical input port and said optical output port, said block having two optical faces substantially normal to said beam path, said beam path making at least two passes between said optical faces and thereby forming a beam path plane;
a permanent magnet structure for producing an intense, unidirectional magnetic field in said Faraday optic in order to induce rotation of the plane of polarization of optical radiation of the beam, said permanent magnet structure including at least six permanent magnets each magnetized along their magnetization axis;
said magnets being attached to outer pole plates at a distal plane surface from the beam path plane and disposed in mirror image magnet sets on opposite sides of the beam path plane with magnets of a first magnet set being disposed generally with like-type poles in transverse registration with the magnets of a second magnet set;
said magnet sets formed of a central block of permanent magnet material with magnetization oriented substantially parallel to the beam path plane and to the optical axis in said Faraday rotator, said central block being adjoined by at least two adjacent blocks of permanent magnet material with magnetization oriented substantially perpendicular to said central magnet block and the beam path plane, the poles of magnets in each said magnet set being the same where the magnets border the beam path plane,
for producing an intense, unidirectional magnetic field in the space between the magnet sets with the unidirectional magnetic field having a predominant component thereof directed generally parallel to the direction of the beam path.

2. The Faraday rotator of claim 1 wherein said permanent magnet structure includes internal pole pieces shaped to further increase magnetic field strength in said Faraday rotator.

3. The Faraday rotator of claim 2 wherein said one or both internal pole pieces have beam transmission holes, said beam transmission holes further acting as apertures that define a unique beam path in the Faraday rotator.

4. The Faraday rotator of claim 1 wherein one or more of said central magnet blocks have projections such that the central magnet blocks substantially surround the non-optical surfaces of said Faraday optic to further increase magnetic field strength in the region of the Faraday optic.

5. The Faraday rotator of claim 1 wherein one or both of said magnet sets are translated normal to said beam path plane in order to tune the amount of rotation of said plane of polarization.

6. The multi-pass Faraday rotator of claim 1 wherein said at least two passes are a result of one or more reflectors.

7. The Faraday rotator of claim 6 with said reflector being comprised of a high reflection alternating high-low refractive index multi-layer thin film coating deposited directly upon said Faraday optic, wherein the first deposition layer onto the Faraday optic of said multi-layer thin film coating is a high index layer with an index of refraction that is greater than the refractive index of the Faraday optic material.

8. The Faraday rotator of claim 6 wherein said reflectors are one or more external high reflection mirrors.

9. The Faraday rotator of claim 1 wherein the region where the beam passes into and out of said Faraday optic is an anti-reflection coating on one or both of said optical faces.

10. The Faraday rotator of claim 1 wherein said optically transparent Faraday material is a glass, polycrystalline ceramic or single crystal where said Faraday effect polarization rotation is due to ferromagnetic, diamagnetic or paramagnetic Faraday effects or by bound or free carriers in semiconductors.

11. The Faraday rotator of claim 1 wherein said Faraday optic comprises said block of optically transparent material having transparent heat-conductive layers of thermally significant thickness bonded to the optical faces to minimize thermal gradients across the beam in the Faraday material.

12. The Faraday rotator of claim 11 wherein said Faraday optic of optically transparent Faraday material is a rectangular slab shaped block.

13. The Faraday rotator of claim 12 wherein said slab shaped block is attached to a heat sink formed of the housing.

14. The Faraday rotator of claim 12 wherein said slab shaped block is actively temperature controlled or stabilized with a thermoelectric device.

15. The Faraday rotator of claim 1 used in a polarization maintaining optical isolator.

16. The Faraday rotator of claim 1 used in a polarization independent optical isolator.
